(19) United States
(12) Patent Application Publication
(10) Pub. No.: US 2025/0037232 A1
(43) Pub. Date: Jan. 30, 2025

(54) IMAGE PROCESSING METHOD AND APPARATUS, ELECTRONIC DEVICE, STORAGE MEDIUM, AND PROGRAM PRODUCT

(71) Applicant: Tencent Technology (Shenzhen) Company Limited, Shenzhen (CN)

(72) Inventors: Hongchuan ZHU, Shenzhen (CN); Wei YAO, Shenzhen (CN)

(21) Appl. No.: 18/911,094

(22) Filed: Oct. 9, 2024

Related U.S. Application Data
(63) Continuation of application No. PCT/CN2023/129971, filed on Nov. 6, 2023.

(30) Foreign Application Priority Data
Dec. 13, 2022 (CN) 2022116036667.1

(51) Int. Cl. G06T 3/40; G06T 5/50; G06T 5/70

(52) U.S. Cl. CPC G06T 3/40; G06T 5/50; G06T 5/70; G06T 2207/20221

(57) ABSTRACT

This application provides an image processing method and apparatus, an electronic device, a computer-readable storage medium, and a computer program product. The method includes: obtaining an image parameter corresponding to a target image, and constructing, based on the image parameter, a mesh for downsampling the target image, the mesh including N mesh cells, the N mesh cells including at least mesh cells of different sizes, and N being a positive integer greater than 1; using the mesh cells in the mesh separately to downsample the target image to obtain N downsampled images; and performing image fusion on the N downsampled images to obtain a target image.

### CROSS-REFERENCE TO RELATED APPLICATIONS

This application is a continuation application of PCT Patent Application No. PCT/CN2023/129971, entitled “IMAGE PROCESSING METHOD AND APPARATUS, ELECTRONIC DEVICE, STORAGE MEDIUM, AND PROGRAM PRODUCT” filed on Nov. 6, 2023, which claims priority to Chinese Patent Application No. 202211603667.1, entitled “IMAGE PROCESSING METHOD AND APPARATUS, ELECTRONIC DEVICE, STORAGE MEDIUM, AND PROGRAM PRODUCT” filed on Dec. 13, 2022, both of which are incorporated herein by reference in their entirety.

### FIELD OF THE TECHNOLOGY

This application relates to the field of computer technologies, and in particular, to an image processing method and apparatus, an electronic device, a computer-readable storage medium, and a computer program product.

### BACKGROUND OF THE DISCLOSURE

There are many special effect processing methods in image processing in related art, such as a Bloom effect, which is a common basic post-processing effect configured for enhancing the contrast between light and dark in a scene and increasing saturation. For the Bloom effect, because it is necessary to increase brightness of a bright region and extend the bright region to a surrounding pixel, a general processing method is to perform downsampling first, then blur, and then perform upsampling. This requires at least six downsampling processes and rendering processes. Consequently, performance overhead is extremely high. In addition, image processing efficiency is low.

### SUMMARY

Embodiments of this application provide an image processing method and apparatus, an electronic device, a computer-readable storage medium, and a computer program product, to improve image processing efficiency.

Technical solutions in embodiments of this application are implemented as follows:

An embodiment of this application provides an image processing method, performed by an electronic device. The method includes:

obtaining an image parameter of a target image;

constructing, based on the image parameter, a mesh for downsampling the target image, the mesh comprising N mesh cells of different sizes, and N being a positive integer greater than 1;

using the mesh cells in the mesh separately to downsample the target image to obtain N downsampled images; and

performing image fusion on the N downsampled images to obtain a target image.

An embodiment of this application provides an electronic device, including:
a memory, configured to store executable instructions; and
a processor, configured to implement, when executing the executable instructions stored in the memory, the image processing method according to embodiments of this application.

An embodiment of this application provides a non-transitory computer-readable storage medium, having computer-executable instructions stored thereon, the computer-executable instructions, when executed by a processor of an electronic device, causing the electronic device to perform the image processing method according to embodiments of this application.

An embodiment of this application provides a computer program product. The computer program product includes a computer program or computer-executable instructions. The computer program or the computer-executable instructions are stored in a computer-readable storage medium. A processor of an electronic device reads the computer-executable instructions from the computer-readable storage medium, and the processor executes the computer-executable instructions, to cause the electronic device to perform the image processing method according to embodiments of this application.

Embodiments of this application have the following beneficial effects:

First, the mesh for downsampling the target image is constructed based on the image parameter of the target image, and then the target image is downsampled through the mesh including a plurality of mesh cells to obtain a plurality of downsampled images, and finally image fusion is performed on the plurality of downsampled images to obtain a target image corresponding to the target image. In this way, the constructed mesh is used to simulate a plurality of downsampling processes, which reduces a quantity of downsamplings during image processing, thereby reducing performance consumption of the electronic device, improving utilization of a hardware processing resource of the electronic device and image processing efficiency, and having wide hardware compatibility.

### BRIEF DESCRIPTION OF THE DRAWINGS

FIG. 1 is a schematic diagram of an architecture of an image processing system 100 according to an embodiment of this application.

FIG. 2 is a schematic diagram of a structure of an electronic device according to an embodiment of this application.

FIG. 3 is a schematic flowchart of an image processing method according to an embodiment of this application.

FIG. 4 is a schematic diagram of comparison between an original image and a target image according to an embodiment of this application.

FIG. 5 is a schematic diagram of a mesh cell according to an embodiment of this application.

FIG. 6 is a schematic diagram of a mesh according to an embodiment of this application.

FIG. 7 is a schematic diagram of a mesh including N mesh cells according to an embodiment of this application.

FIG. 8 is a schematic diagram of a process of downsampling a target image according to an embodiment of this application.

FIG. 9 is a schematic diagram of N downsampled images according to an embodiment of this application.

FIG. 10 is a schematic diagram of a spliced image according to an embodiment of this application.

FIG. 11 is a schematic flowchart of performing special effect processing on a target image according to an embodiment of this application.

FIG. 12 is a schematic diagram of a blurred image according to an embodiment of this application.

FIG. 13 is a schematic diagram of N downsampled images according to an embodiment of this application.

FIG. 14 is a schematic diagram of a special effect image including N special effect image regions according to an embodiment of this application.

FIG. 15 is a schematic diagram of a target image according to an embodiment of this application.

FIG. 16 is a schematic diagram of a process in which an original image is superimposed on a target image to obtain a target special effect image according to an embodiment of this application.

FIG. 17 is a schematic flowchart of an image processing method according to an embodiment of this application.

FIG. 18 is a schematic diagram of an architecture of an image processing method according to an embodiment of this application.

### DESCRIPTION OF EMBODIMENTS

To make the objectives, technical solutions, and advantages of this application clearer, the following describes this application in detail with reference to the accompanying drawings. The described embodiments are not to be considered as a limitation to this application. All other embodiments obtained by a person of ordinary skill in the art without creative efforts shall fall within the protection scope of this application.

In the following description, the term “some embodiments” describes subsets of all possible embodiments, but “some embodiments” may be the same subset or different subsets of all the possible embodiments, and can be combined with each other without conflict.

In the following description, the terms “first”, “second”, and “third” are merely intended to distinguish between similar objects rather than describe specific orders. The terms “first”, “second”, and “third” may, where permitted, be interchangeable in a particular order or sequence, so that embodiments of this application described herein may be performed in an order other than that illustrated or described herein.

Unless otherwise defined, meanings of all technical and scientific terms used in this specification are the same as those usually understood by a person skilled in the art to which this application belongs. Terms used in the specification are merely intended to describe objectives of embodiments of this application, but are not intended to limit this application.

Before embodiments of this application are described in detail, a description is made on terms in embodiments of this application, and the terms in embodiments of this application are applicable to the following explanations.

(1) A client is a program corresponding to a server that provides a local service to a user. In addition to some applications that can only run locally, the client is generally installed on an ordinary user device and needs to cooperate with the server to run. In other words, the client requires a corresponding server and service program in a network to provide a corresponding service. In this way, a specific communication connection needs to be established on the client and a server side, to ensure a normal operation of an application.

(2) A render target (RT) is configured to render a video memory buffer of a pixel, that is, a memory region. There may be a plurality of such memory regions at the same time, in other words, there may be a plurality of render targets at the same time.

(3) A draw call is an operation that a central processing unit (CPU) calls a graphic programming interface to instruct a graphic processing unit (GPU) to perform rendering. Before each draw call, the CPU needs to send a lot of content to the GPU, such as data, a status, and a command.

(4) Render Pass (abbreviated as Pass): a Render Pass represents a complete rendering process, including a render target switch and a series of Draw Call calls. A drawn render target is used for subsequent rendering processes.

(5) Gaussian Blur is also referred to as Gaussian smoothing, for calculating transformation of each pixel in an image based on normal distribution, and is usually used to reduce image noise and reduce a level of image details. A visual effect of an image generated by Gaussian blur is like observing the image through frosted glass. A Gaussian blur processing process generally has a Horizontal Blur Pass (horizontal blur rendering process) and a Vertical Blur Pass (vertical blur rendering process). To be specific, all pixels are processed horizontally once, and then all the pixels are processed vertically again. A final Gaussian blur result is obtained through the two rendering processes.

(6) Texture sampling is a function of obtaining corresponding texture data according to some set rules (such as a sampler, a filter).

(7) Downsampling is also referred to as down-sampling, and is configured for zooming out an image and reducing a resolution of the image.

(8) Upsampling is also referred to as image interpolation, and is configured for zooming in an image and improving a resolution of the image, such as using an interpolation method to improve the resolution.

(9) UV coordinates are texture mapping coordinates, where U is a horizontal coordinate and V is a vertical coordinate, which define position information of each point on an image and are configured to accurately correspond to the point on the image to a surface of a model object. In practice, texture mapping coordinates are available at points on the surface of a mesh, and the texture mapping coordinates define a two-dimensional position corresponding to a three-dimensional position in a texture map.

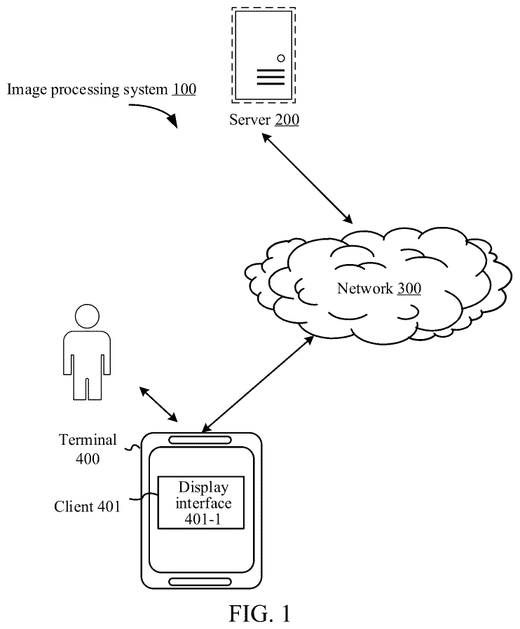

FIG. 1 is a schematic diagram of an architecture of an image processing system 100 according to an embodiment of this application. To achieve an application scenario of image processing (for example, the application scenario of the image processing may be that when a halo special effect is added to an original image, first, a pixel point of which a brightness value in an original special effect is higher than a brightness threshold is extracted, a target image is determined based on the extracted pixel point, a mesh constructed based on the target image is used to downsample the target image to obtain a plurality of downsampled images, then image fusion is performed on the plurality of downsampled images to obtain a target image, and the target image is superimposed on the original image to obtain a target special effect image with the halo special effect added), a terminal (a terminal 400 is shown as an example) is connected to a server 200 via a network 300, and the network 300 may include a wide area network or a local area network, or a combination of the two. The terminal 400 is configured to provide a client 401 for a user, and is displayed on a display interface (a display interface 401-1 is shown as an example), and the terminal 400 is connected to the server 200 via a wired or wireless network.

The terminal 400 is configured to obtain an original image; and determine a target image based on the original image, and transmit the target image to the server 200.

The server 200 is configured to receive the target image; obtain an image parameter of the target image, and construct, based on the image parameter, a mesh that matches the target image, the mesh including N mesh cells, the N mesh cells including at least mesh cells of different sizes, and N being a positive integer greater than 1; use the mesh cells in the mesh separately to downsample the target image to obtain N downsampled images; perform image fusion on the N downsampled images to obtain a target image; and transmit the target image corresponding to the target image to the terminal 400.

The terminal 400 is further configured to: receive the target image and superimpose the target image on the original image to obtain a target special effect image with a special effect added; and display the target special effect image based on the display interface.

In some embodiments, the server 200 may be an independent physical server, a server cluster or distributed system composed of a plurality of physical servers, and a cloud server providing basic cloud computing services, such as a cloud service, a cloud database, cloud computing, a cloud function, a network service, cloud communication, a middleware service, a domain name service, a security service, a content delivery network (CDN), and a big data and artificial intelligence platform. The terminal 400 may include a smart phone, a tablet computer, a laptop, a desktop computer, a set-top box, an intelligent voice interaction device, a smart home appliance, an on-board terminal, an aircraft, and a mobile device (for example, a mobile phone, a portable music player, a personal digital assistant, a dedicated messaging device, a portable gaming device, a smart speaker, and a smart watch), and the like, but is not limited thereto. The terminal device may be connected directly or indirectly to the server in a wired or wireless communication manner, which is not limited in this application.

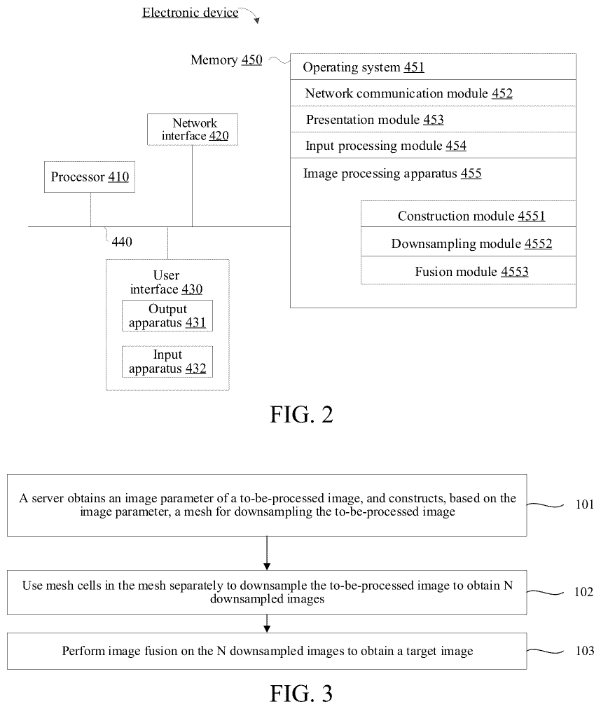

FIG. 2 is a schematic diagram of a structure of an electronic device according to an embodiment of this application. During actual application, the electronic device may be the server 200 or the terminal 400 shown in FIG. 1. Refer to FIG. 2. The electronic device shown in FIG. 2 includes: at least one processor 410, a memory 450, at least one network interface 420, and a user interface 430. Components in the terminal 400 are coupled by a bus system 440. The bus system 440 is configured to implement connection and communication between the components. In addition to a data bus, the bus system 440 further includes a power bus, a control bus, and a state signal bus. However, for ease of clear description, all types of buses in FIG. 2 are marked as the bus system 440.

The processor 410 may be an integrated circuit chip with a signal processing capability, such as a general-purpose processor, a digital signal processor (DSP), or another programmable logic device, discrete gate, transistor logic device, or discrete hardware component. The general-purpose processor may be a microprocessor, any conventional processor, or the like.

The user interface 430 includes one or more output apparatuses 431 that render media content, including one or more loudspeakers and/or one or more visual display screens. The user interface 430 further includes one or more input apparatuses 432 including user interface members that help user input, such as a keyboard, a mouse, a microphone, a touch display screen, a camera, other input buttons and controls.

The memory 450 may be removable, non-removable, or a combination thereof. For example, a hardware device includes a solid-state memory, a hard disk drive, an optical drive, and the like. In some embodiments, the memory 450 includes one or more storage devices physically located away from the processor 410.

The memory 450 may include a volatile memory or a non-volatile memory, or may include both a volatile memory and a non-volatile memory. The non-volatile memory may be a read-only memory (ROM), and the volatile memory may be a random access memory (RAM). The memory 450 described in this embodiment of this application is intended to include any suitable types of memories.

In some embodiments, the memory 450 can store data to support various operations, and examples of the data include a program, a module, and a data structure, or a subset or a superset thereof, which are described below by using example.

An operating system 451 includes a system program configured to process various basic system services and perform hardware-related tasks, such as a frame layer, a core library layer, and a drive layer, and is configured to implement various basic services and process hardware-based tasks.

A network communication module 452 is configured to reach another electronic device via one or more (wired or wireless) network interfaces 420. For example, the network interface 420 includes: Bluetooth, wireless fidelity (Wi-Fi), a universal serial bus (USB), and the like.

A presentation module 453 is configured to present information by one or more output apparatuses 431 (for example, a display screen and a speaker) associated with the user interface 430 (for example, a user interface configured to operate a peripheral device and display content and information).

An input processing module 454 is configured to detect one or more user input or interactions from one of the one or more input apparatuses 432 and translate the detected input or interactions.

In some embodiments, the apparatus provided in this embodiment of this application may be implemented in a software manner. FIG. 2 shows an image processing apparatus 455 stored in the memory 450. The apparatus 455 may be software in the form of a program and a plug-in, and the like, and includes the following software modules: a construction module 4551, a downsampling module 4552, and a fusion module 4553. These modules are logical, so that the modules can be arbitrarily combined or split according to implemented functions. The functions of the modules are described below.

In some other embodiments, the apparatus provided in this embodiment of this application may be implemented in a hardware manner. As an example, the image processing apparatus provided in this embodiment of this application may be a processor in the form of a hardware decoding processor. The processor is programmed to perform the image processing method provided in embodiments of this application. For example, the processor in the form of a hardware decoding processor may use one or more application-specific integrated circuits (ASICs), DSPs, programmable logic devices (PLDs), complex programmable logic devices (CPLDs), field-programmable gate arrays (FPGAs), or other electronic elements.

In some embodiments, the terminal or the server may implement the image processing method provided in embodiments of this application by running a computer program. For example, the computer program may be a native program or a software module in an operating system, may be a native application (APP), that is, a program that needs to be installed in the operating system to run, such as an instant messaging APP, a web browser APP, may be a mini program, that is, a program that only needs to be downloaded into a browser environment to run; or may be a mini program that can be embedded in any APP. In conclusion, the foregoing computer program may be any form of application, module, or plug-in.

Based on the foregoing descriptions of the image processing system and the electronic device provided in embodiments of this application, the following describes an image processing method provided in embodiments of this application. During actual implementation, the image processing method provided in embodiments of this application may be implemented by a terminal or a server alone, or by a terminal and a server collaboratively. An example in which the server 200 in FIG. 1 performs the image processing method provided in embodiments of this application alone is used for description. 3. FIG. 3 is a schematic flowchart of an image processing method according to an embodiment of this application, which is described with reference to operations shown in FIG. 3.

Operation 101: A server obtains an image parameter of a target image, and constructs, based on the image parameter, a mesh for downsampling the target image.

The mesh includes N mesh cells, the N mesh cells include at least mesh cells of different sizes, and N is a positive integer greater than 1.

During actual implementation, the target image may be prestored locally on a terminal, or may be obtained by the terminal from the outside world (such as the Internet), or may be obtained by obtaining an original image before obtaining the image parameter corresponding to the target image, and then determining, based on the original image, the target image corresponding to the original image. There are a plurality of manners to determine the target image based on the original image. The original image may be prestored locally on the terminal, or may be obtained from the outside world (such as the Internet), or collected in real time, for example, collected in real time by a photography apparatus. For a process of determining, based on the original image, the target image corresponding to the original image, the following uses two manners as examples to separately describe the process of determining, based on the original image, the target image corresponding to the original image.

In some embodiments, an original image is obtained and a plurality of pixel points corresponding to original image are determined. The plurality of pixel points are screened based on brightness of the pixel points, to obtain at least one target pixel point. The target image is determined based on the least one target pixel point. After determining the plurality of pixel points corresponding to the original image, the brightness of the pixel points needs to be determined first based on the plurality of pixel points.

During actual implementation, there are a plurality of manners to determine the brightness of the pixel points based on the plurality of pixel points. Next, the following uses one of the manners as an example to describe the process of determining the brightness of the pixel points based on the plurality of pixel points. In some embodiments, the process of determining the brightness of the pixel points based on the plurality of pixel points may include: first, sampling, based on the plurality of pixel points, three color values corresponding each of the pixel points, where the color values may be represented by using a red, green, and blue (RGB) model, to be specific, the three color values of each of the pixel points are color values under three color channels of red (R), green (G), and blue (B), and determining the brightness of the pixel points based on the three color values.

The process of determining the brightness of the pixel points based on the three color values may include: comparing the three color values for the pixel points, and selecting, based on a comparison result, a greatest color value from the three color values as a brightness value of each of the pixel points, that is, the brightness of each of the pixel points; or obtaining weights of the color values for the pixel points, to perform a weighted summation on the three color values, and using an obtained weighted summation result as the brightness value of each of the pixel points, that is, the brightness of each of the pixel points.

During actual implementation, the process of screening the plurality of pixel points based on the brightness of the pixel points, to obtain at least one target pixel point may include: obtaining a preset brightness threshold (where a value of the brightness threshold may be set based on an actual need), comparing the brightness of the pixel points with the brightness threshold, and selecting, based on a comparison result, a pixel point with a brightness value greater than the brightness threshold from the plurality of pixel points as the target pixel point.

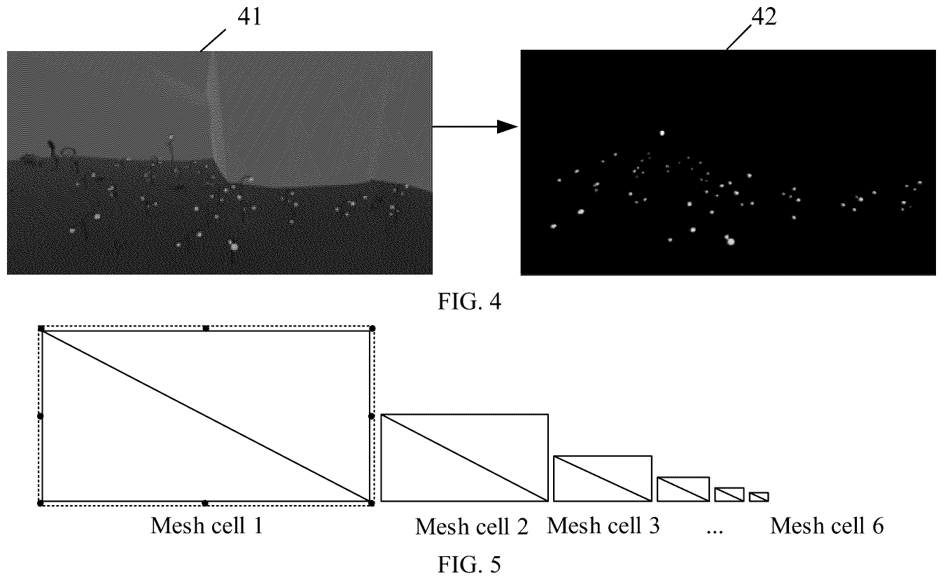

For example, FIG. 4 is a schematic diagram of a comparison between an original image and a target image according to an embodiment of this application. After obtaining an original image 41, pixel points in the original image 41 are screened based on the preset brightness threshold, to obtain a pixel point of which brightness is not less than the brightness threshold as the target pixel point, so that a target image as shown in number 42 is determined based on the target pixel point.

In some other embodiments, an original image and an image segmentation model are obtained. Image segmentation is performed on the original image based on the image segmentation model, to obtain a segmented image. The segmented image is used as the target image. The image segmentation model is pre-trained. For example, when the image segmentation model is configured for face recognition, the target image is a face part of the original image. When the image segmentation model is configured for background recognition, the target image is a background part of the original image. In this way, different target images are obtained through different image segmentation models, to carry out subsequent special effect processing processes, thereby improving applicability of an image processing process.

The image parameter corresponding to the target image may include a resolution, a size, a quantity of renderings, and the like of the target image. During actual implementation, based on the image parameter, the mesh for downsampling the target image may be constructed in the following manner:

obtaining the image parameter of the target image (such as a quantity of renderings and a resolution), determining, based on the image parameter, a target quantity of mesh cells included in the mesh, and generating N (that is, the target quantity) mesh cells based on the image parameter of the target image. A value of N is the same as the target quantity of the mesh cells included in the mesh, and sizes of the mesh cells are halved starting from the first mesh cell. Then, the N mesh cells are spliced based on a preset cell distance to obtain the mesh including the N mesh cells. In this way, based on the preset cell distance, the mesh cells are arranged closely and space waste is reduced while a specific gap is left, to prevent, when special effect processing is performed on pixel points in the mesh cells, colors of edges of the mesh cells from diffusing to another adjacent mesh cell.

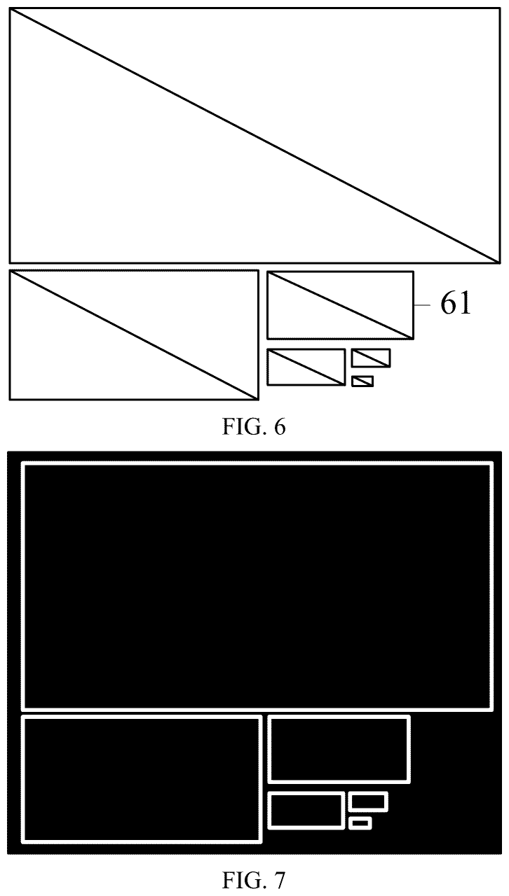

For example, FIG. 5 is a schematic diagram of a mesh cell according to an embodiment of this application. According to FIG. 5, the resolution of the original image may be 1920*1080, and N is 6, so that six mesh cells, namely, mesh cell 1 with a resolution of 960*540, mesh cell 2 with a resolution of 480*270, mesh cell 3 with a resolution of 240*135, mesh cell 4 with a resolution of 120*68, mesh cell 5 with a resolution of 60*34, and mesh cell 6 with a resolution of 30*17, are generated based on the resolution of the original image. Then, FIG. 6 is a schematic diagram of a mesh according to an embodiment of this application. According to FIG. 6, after six mesh cells (where a mesh cell 61 is shown in the figure as an example) are generated, the six mesh cells are spliced based on a preset cell distance to obtain the mesh including the six mesh cells.

The size of the mesh cell is related to the resolution of the image and N. The mesh cell may be a rectangle composed of two triangles or a square composed of two triangles, which is not limited in embodiments of this application. In addition, after the mesh including the N mesh cells is generated, positions of the mesh cells in the mesh may also be recorded and stored in the form of UV coordinates, so that in a subsequent process, the positions of the mesh cells in the mesh can be directly determined based on the stored related information.

Operation 102: Use the mesh cells in the mesh separately to downsample the target image to obtain N downsampled images.

During actual implementation, after a mesh including a plurality of mesh cells is created, the target image may be downsampled based on the mesh cells in the mesh. In some embodiments, the target image may be downsampled based on the mesh cells in the mesh to obtain the N downsampled images in the following manner: obtaining sizes of the mesh cells in the mesh; and downsampling the target image based on the sizes of the mesh cells to obtain the N downsampled images.

In actual application, the sizes of the mesh cells may include areas and dimensions of the mesh cells, so that the target image may be downsampled based on the areas and dimensions of the mesh cells to obtain the N downsampled images.

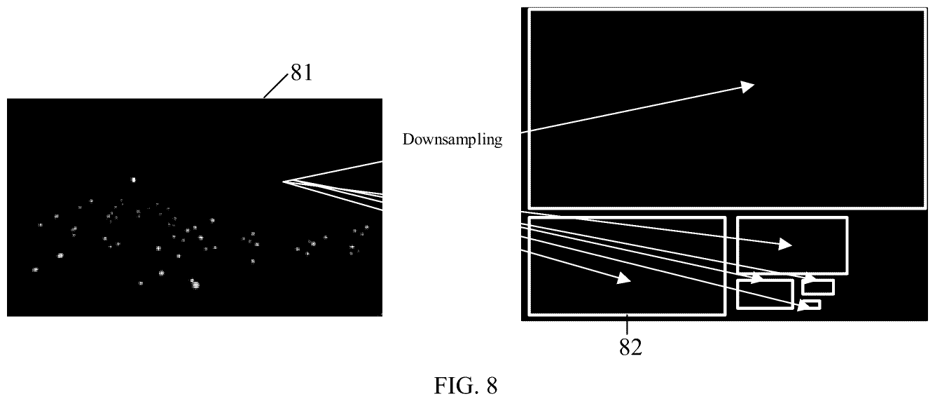

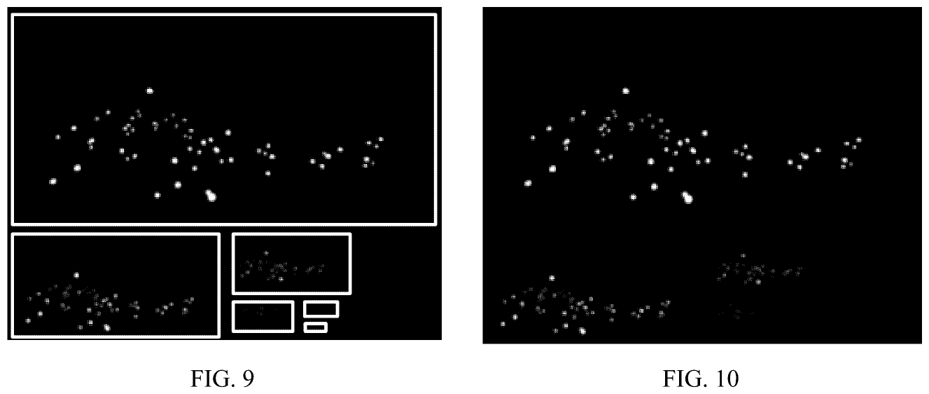

For example, FIG. 7 is a schematic diagram of a mesh including N mesh cells according to an embodiment of this application. According to FIG. 7, the mesh includes six mesh cells. Then refer to FIG. 8 and FIG. 9. FIG. 8 is a schematic diagram of a process of downsampling a target image according to an embodiment of this application. Refer to FIG. 8. A target image 81 is downsampled to obtain six downsampled images (where a downsampled image 82 is shown in the figure as an example). FIG. 9 is a schematic diagram of N downsampled images according to an embodiment of this application. According to FIG. 8, the target image is downsampled based on sizes of the mesh cells, to obtain six downsampled images as shown in FIG. 9.

Operation 103: Perform image fusion on the N downsampled images to obtain a target image.

During actual implementation, an image fusion process may include an image splicing process. In some embodiments, after the N downsampled images are determined, the image fusion may be performed on the N downsampled images to obtain the target image in the following manner: obtaining positions of the mesh cells in the mesh; splicing the N downsampled images based on the positions of the mesh cells to obtain a spliced image; and performing image fusion on the spliced image to obtain the target image.

For example, FIG. 10 is a schematic diagram of a spliced image according to an embodiment of this application. According to FIG. 10, after the six downsampled images shown in FIG. 9 are obtained, the six downsampled images are spliced to obtain the spliced image as shown in FIG. 10, and then image fusion is performed on downsampled images in the spliced image as shown in FIG. 10 to obtain the target image.

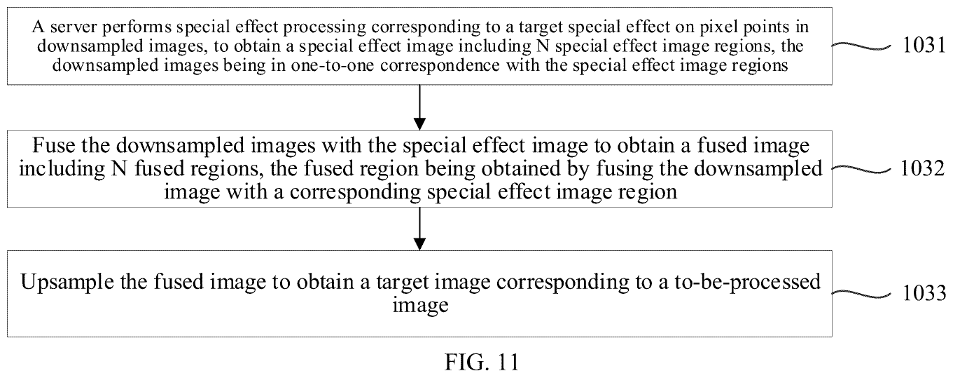

In some embodiments, in a process of performing image fusion on the N downsampled images to obtain the target image, there is also an operation of performing special effect processing on the downsampled images. FIG. 11 is a schematic flowchart of performing special effect processing on a target image according to an embodiment of this application. According to FIG. 11, operation 103 may alternatively be implemented by using the following operations.

Operation 1031: Perform special effect processing of a target special effect on pixel points in the downsampled images, to obtain a special effect image including N special effect image regions, the downsampled images being in one-to-one correspondence with the special effect image regions.

The special effect processing of the target special effect is performed on the pixel points in the downsampled images, in other words, processing is performed on the pixel points in the downsampled images to cause the pixel points to have a specific special effect. The target special effect includes but is not limited to a halo special effect, a highlight special effect, a sticker special effect, and the like. During actual application, target special effects are different, and processes of performing the special effect processing of the target special effect on the pixel points in the downsampled images are also different. The following uses two target special effects as examples to describe the process of performing special effect processing.

In some embodiments, when the target special effect is a halo special effect, Gaussian blur is performed on the pixel points in the downsampled images to obtain a blurred image including N blurred image regions. The downsampled images are in one-to-one correspondence with the blurred image regions. In another embodiment, when the target special effect is a highlight special effect, brightness of the pixel points in the downsampled images is increased to obtain a highlight image including N highlight image regions. The downsampled images are in one-to-one correspondence with the highlight image regions.

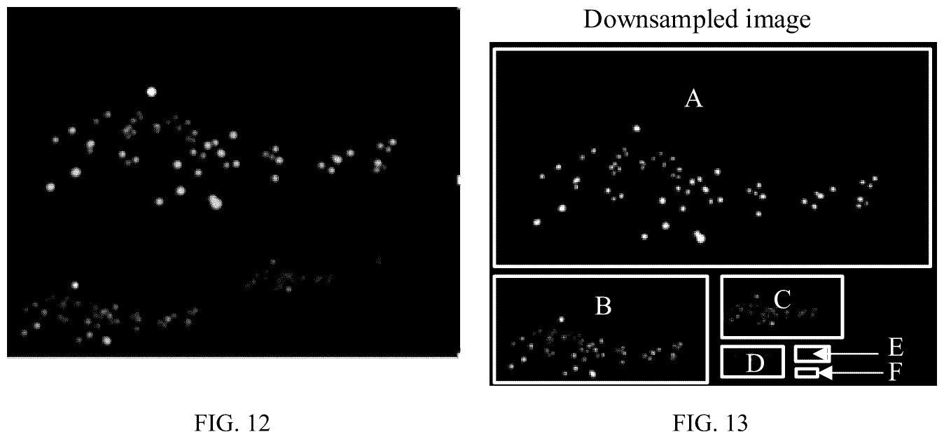

When the target special effect is the halo special effect, the process of performing Gaussian blur on the pixel points in the downsampled images includes horizontal processing and vertical processing. For example, FIG. 12 is a schematic diagram of a blurred image according to an embodiment of this application. According to FIG. 12, when the target special effect is the halo special effect, horizontal Gaussian blur is performed on the pixel points in the downsampled image to obtain a horizontal Gaussian blur processing result, and then vertical Gaussian blur processing is performed on pixel points of the horizontal Gaussian blur processing result to obtain a vertical Gaussian blur processing result. The vertical Gaussian blur processing result is used as the blurred image including the N blurred image regions.

When the process of performing Gaussian blur on the pixel points in the downsampled images includes the horizontal processing and the vertical processing, an order of performing the horizontal processing and the vertical processing can be adjusted. For example, when the target special effect is the halo special effect, first, the vertical Gaussian blur is performed on the pixel points in the downsampled images to obtain the vertical Gaussian blur processing result, and then the horizontal Gaussian blur processing is performed on pixel points of the vertical Gaussian blur processing result to obtain the horizontal Gaussian blur processing result. The horizontal Gaussian blur processing result is used as the blurred image including the N blurred image regions.

Operation 1032: Fuse the downsampled images with the special effect image to obtain a fused image including N fused regions, the fused region being obtained by fusing the downsampled image with a corresponding special effect image region.

Due to differences in target special effects, there are also a plurality of types of special effect images, so that there are also a plurality of manners to fuse the downsampled images with the special effect image. The following uses two manners as examples to describe the process of fusing the downsampled images with the special effect image to obtain the fused image including the N fused regions.

In some embodiments, when the target special effect is a halo special effect and the special effect image is a blurred image, the process of fusing the downsampled images with the special effect image to obtain the fused image including the N fused regions may include: fusing the downsampled images with the blurred image to obtain a fused image including N blurred special effect fused regions. In another embodiment, when the target special effect is a highlight special effect and the special effect image is a highlight image, the process of fusing the downsampled images with the special effect image to obtain the fused image including the N fused regions may include: fusing the downsampled images with the highlight image to obtain a fused image including N highlight special effect fused regions.

During actual implementation, the process of fusing the downsampled images with the special effect image is the process of fusing the downsampled images with the special effect image regions in the special effect image, so that after the downsampled images and the special effect image are determined, the process of fusing the downsampled images with the special effect image to obtain the fused image including the N fused regions may include: fusing the downsampled images with corresponding special effect image regions in the special effect image to obtain the N fused regions; and determining, based on the N fused regions, the fused image including the N fused regions.

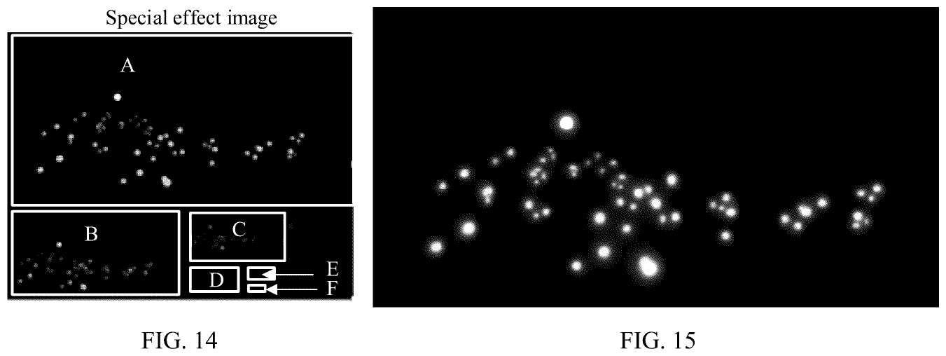

For example, refer to FIG. 13 and FIG. 14. FIG. 13 is a schematic diagram of N downsampled images according to an embodiment of this application. FIG. 14 is a schematic diagram of a special effect image including N special effect image regions according to an embodiment of this application. According to FIG. 13, the downsampled images include six downsampled images, namely, A, B, C, D, E, and F. According to FIG. 14, the special effect image includes six special effect image regions, namely, special effect image region A, special effect image region B, special effect image region C, special effect image region D, special effect image region E, and special effect image region F. The downsampled images are fused with the corresponding special effect image regions in the special effect image to obtain N fused regions. To be specific, downsampled image A is fused with special effect image region A to obtain fused region A, downsampled image B is fused with special effect image region B to obtain fused region B, downsampled image C is fused with special effect image region C to obtain fused region C, downsampled image D is fused with special effect image region D to obtain fused region D, downsampled image E is fused with special effect image region E to obtain fused region E, and downsampled image F is fused with special effect image region F to obtain fused region F, so that a fused image including the six fused regions is determined based on the six fused regions.

In some embodiments, in the process of fusing the downsampled images with the corresponding special effect image regions in the special effect image to obtain the N fused regions, fusion effects of the fused regions may be adjusted by adjusting fusion weights respectively corresponding to the downsampled images. For example, the process of fusing the downsampled images with the corresponding special effect image regions in the special effect image to obtain the N fused regions may include: obtaining first weights respectively corresponding to the downsampled images; and performing weighted fusion on the downsampled images and the corresponding special effect image regions based on the first weights, to obtain the N fused regions. The first weight is the fusion weight corresponding to each of the downsampled images. The first weight may be preset based on the fusion effect.

Operation 1033: Upsample the fused image to obtain the target image corresponding to the target image.

Due to the differences in target special effects, there are also a plurality of types of special effect images and fused images, so that there are also a plurality of processes of upsampling the fused image to obtain the target image corresponding to the target image. The following uses two manners as examples to describe the process of upsampling the fused image to obtain the target image corresponding to the target image.

In some embodiments, when the target special effect is the halo special effect and the fused image is the fused image including the N blurred special effect fused regions, the process of upsampling the fused image to obtain the target image corresponding to the target image may include upsampling the fused image to obtain the target image corresponding to the target image with the halo special effect added. In another embodiment, when the target special effect is the highlight special effect and the fused image is the fused image including the N highlight special effect fused regions, the process of upsampling the fused image to obtain the target image corresponding to the target image may include upsampling the fused image to obtain the target image corresponding to the target image with the highlight special effect added.

During actual implementation, the process of upsampling the fused image is the process of upsampling the fused regions in the fused image, so that after the fused image is determined, the process of upsampling the fused image to obtain the target image corresponding to the target image may include: determining values of the pixel points in the fused regions based on the fused image; and upsampling the fused image based on the values of the pixel points in the fused regions, to obtain the target image corresponding to the target image.

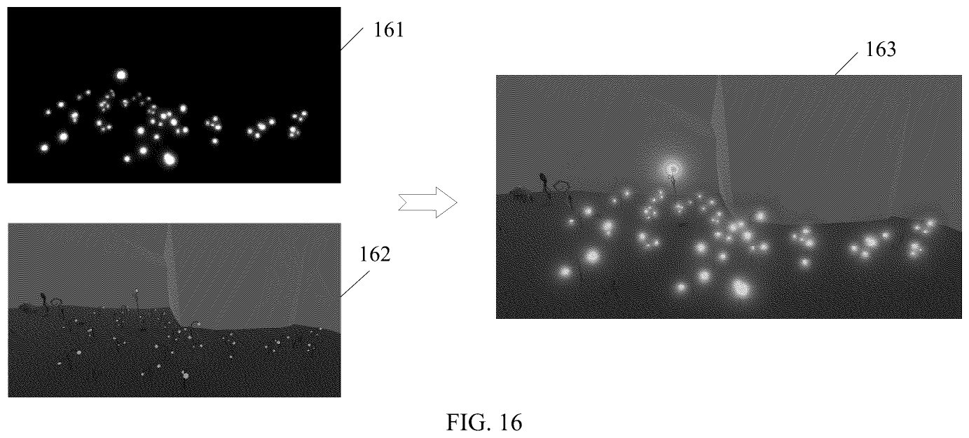

For example, FIG. 15 is a schematic diagram of a target image according to an embodiment of this application. According to FIG. 15, the fused image is upsampled based on the values of the pixel points in the fused regions, to obtain the target image shown in FIG. 15.

For the process of determining the values of the pixel points in the fused regions based on the fused image, positions of the fused regions may be obtained first, and the positions of the fused regions are in one-to-one correspondence with the positions of the mesh cells in the mesh, so that the values of the pixel points in the fused region are determined based on the fused image and the positions of the fused regions.

In some embodiments, in the process of upsampling the fused image to obtain the target image corresponding to the target image, an effect of a special effect of the target image may be adjusted by adjusting upsampling weights corresponding to the fused regions. For example, the process of upsampling the fused image based on the values of the pixel points in the fused regions, to obtain the target image corresponding to the target image may include: obtaining second weights corresponding to the fused regions; and performing weighted synthesis on the values of the pixel points in the fused regions based on the second weight, to obtain the target image corresponding to the target image. The second weight is the upsampling weight corresponding to each of the fused regions. The second weight may be preset based on the effect of the special effect of the target image. The second weight may be the same as or different from the first weight.

In some embodiments, after the fused image is upsampled to obtain the target image corresponding to the target image, the original image may be further superimposed on the target image to obtain a target special effect image. The target special effect image is transmitted to a terminal, to enable the terminal to display the target special effect image. For example, FIG. 16 is a schematic diagram of a process in which an original image is superimposed on a target image to obtain a target special effect image according to an embodiment of this application. According to FIG. 16, after the target image is determined, the target special effect image shown in FIG. 16 is obtained by superimposing the original image on the target image.

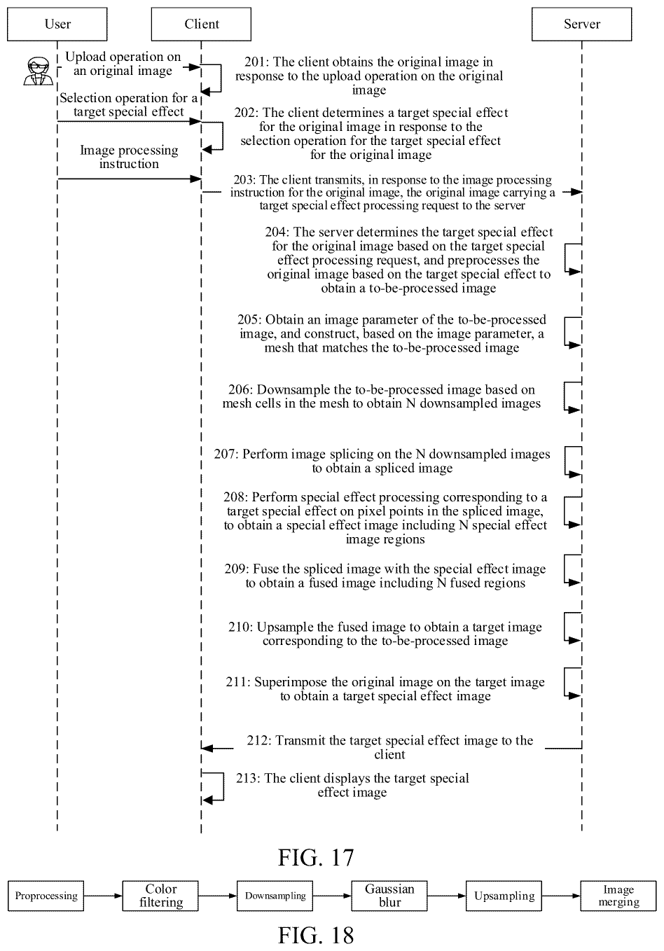

The following continues to describe the image processing method provided in embodiments of this application. FIG. 17 is a schematic flowchart of an image processing method according to an embodiment of this application. According to FIG. 17, the image processing method provided in this embodiment of this application is implemented collaboratively by a client and a server.

Operation 201: The client obtains an original image in response to an upload operation on the original image.

During actual implementation, the client may be an image processing client installed on a terminal. A user triggers, based on a human-computer interaction interface of the client, an upload function item for uploading an image in the human-computer interaction interface, so that the client presents an image selection interface on the human-computer interaction interface. The user selects, based on the image selection interface, an image locally on the terminal (such as a local album) as the original image, or selects an image stored in cloud space as the original image, or takes an image through a camera communicatively connected to the terminal as the original image, and then uploads the original image, so that the client obtains the uploaded original image.

Operation 202: The client determines a target special effect for the original image in response to a selection operation for the target special effect for the original image.

During actual implementation, after the user uploads the original image based on the human-computer interaction interface of the client, the client presents a special effect selection interface including a plurality of candidate special effects on the human-computer interaction interface. The user selects the target special effect based on the special effect selection interface, to enable the client to determine the target special effect for the original image.

Operation 203: The client transmits, in response to an image processing instruction for the original image, the original image carrying a target special effect processing request to the server.

During actual implementation, the image processing instruction for the original image may be automatically generated by the client under a specific trigger condition. For example, the client automatically generates the image processing instruction for the original image after determining the target special effect for the original image. Alternatively, the image processing instruction may be sent to the client by another device communicatively connected to the terminal. Alternatively, the image processing instruction may be generated by triggering a corresponding confirmation function item by the user based on the human-computer interaction interface of the client.

Operation 204: The server determines the target special effect for the original image based on the target special effect processing request, and preprocesses the original image based on the target special effect to obtain a target image.

During actual application, the process of preprocessing the original image may be a process of screening pixel points in the original image. For example, the server obtains brightness of the pixel points in the original image, and screens, based on the brightness of the pixel points in the original image, a plurality of pixel points to obtain pixel points of which brightness is not lower than a brightness threshold as target pixel points, and determines an image including the plurality of target pixel points screened out as the target image.

Operation 205: Obtain an image parameter of the target image, and construct, based on the image parameter, a mesh that matches the target image.

The mesh includes N mesh cells, the N mesh cells include at least mesh cells of different sizes, N is a positive integer greater than 1, and the image parameter may include at least one of a quantity of renderings, a size, or a resolution. The mesh that matches the target image means that a quantity of mesh cells and the sizes of the mesh cells included in the constructed mesh are determined based on the image parameter of the target image.

Operation 206: Downsample the target image based on the mesh cells in the mesh to obtain N downsampled images.

Operation 207: Perform image splicing on the N downsampled images to obtain a spliced image.

Operation 208: Perform special effect processing corresponding to a target special effect on pixel points in the spliced image, to obtain a special effect image including N special effect image regions.

The downsampled images in the spliced image are in one-to-one correspondence with the special effect image regions.

Operation 209: Fuse the spliced image with the special effect image to obtain a fused image including N fused regions.

The fused region is obtained by fusing the downsampled image in the spliced image with a corresponding special effect image region.

Operation 210: Upsample the fused image to obtain a target image corresponding to the target image.

Operation 211: Superimpose the original image on the target image to obtain a target special effect image.

Operation 212: Transmit the target special effect image to the client.

Operation 213: The client displays the target special effect image.

During actual implementation, the client may display the target special effect image on the human-computer interaction interface of the client, may save the target special effect image locally on the terminal, may transmit the target special effect image to another device communicatively connected to the terminal, or the like.

According to embodiments of this application, first, the mesh that matches the to-be target image is constructed based on the image parameter of the target image, and then the target image is downsampled through the mesh including a plurality of mesh cells to obtain the N downsampled images, and finally image fusion is performed on a plurality of downsampled images to obtain the target image corresponding to the target image. In this way, the constructed mesh that matches the target image is used to simulate a plurality of downsampling processes, to reduce a quantity of downsamplings during image processing, thereby reducing performance consumption, improving image processing efficiency, and having wide hardware compatibility.

The following describes exemplary application of embodiments of this application in an actual application scenario.

The inventor has found that, in related art, when a Bloom effect (blooming) is performed on an image, it is necessary to increase brightness of a bright region and extend the bright region to a surrounding pixel, a general processing method is to perform downsampling first, then blur, and then perform upsampling. To be specific, such a processing method needs more than 10 rendering processes. For example, the Bloom effect used by a Unity engine has a total of 19 rendering processes. First, in a first rendering process, it is necessary to extract a pixel that needs to be floodlit, then downsampling is performed based on the extracted pixel, and Gaussian blur is performed while downsampling is performed. After each downsampling, Gaussian blur is performed, and a result is used for downsampling again, which is repeated six times. Because Gaussian blur is needed during the downsampling, and each Gaussian blur needs two rendering processes, such six downsamplings need a total of 12 rendering processes. Finally, images before and after each Gaussian blur are merged during the downsampling, and finally results of the six downsamplings are merged, in other words, render targets during the downsampling are merged to obtain a final effect. This requires a total of six rendering processes. Therefore, the Bloom effect used by the Unity engine needs a total of 19 rendering processes. Consequently, performance overhead is high, and special effect processing efficiency is low.

In view of this, embodiments of this application provide an image processing method and apparatus, an electronic device, a computer-readable storage medium, and a computer program product, to perform rendering based on a special mesh, so as to replace six downsampling processes and six upsampling processes based on the mesh, thereby reducing performance consumption, improving special effect processing efficiency, and having wide hardware compatibility.

Any hardware device with a GPU (a display chip), such as a computer, a mobile phone, and a game console, can implement the technical solution of this application. For implementation logic of the technical solution of this application, a pixel that needs to be floodlit (the target pixel point) is first screened out, and then a pregenerated special mesh is used to perform downsampling, Gaussian blur, and upsampling in sequence based on the pixel, to obtain a target image. Finally, the target image is merged into an original image to obtain a final floodlit effect (a target special effect image).

FIG. 18 is a schematic diagram of an architecture of an image processing method according to an embodiment of this application. According to FIG. 18, the image processing method provided in this embodiment of this application is implemented through the following six operations, namely, a preprocessing process, a color filtering process, a downsampling process, a Gaussian blur process, an upsampling process, and an image merging process.

For the preprocessing process, first, a special mesh is pregenerated to simulate a process of a plurality of downsamplings. Generally, full-screen drawing requires two triangles to form a rectangle (a mesh cell) to cover a drawing range. A mesh including six rectangles of different sizes is generated based on resolutions corresponding to six downsamplings. For example, six rectangles of which sizes are halved in sequence are generated based on screen resolutions. For example, if a screen resolution is 1920*1080, the six rectangles as shown in FIG. 5 are generated. Then the six rectangles are merged into the mesh as shown in FIG. 6, and the six rectangles are arranged closely to reduce space waste. A specific gap needs to be left between a plurality of rectangles to prevent colors of rectangle edges from diffusing to other adjacent rectangular regions during subsequent Gaussian blur. Next, UV ranges corresponding to the six rectangles in the mesh are recorded in the form of a list, and the list is stored for use in the upsampling process. The process of recording the six rectangles in the corresponding UV ranges in the form of a list can be implemented by the following code, that is,

public struct Rect
{
public float xMin;
public float xMax;
public float yMin;
public float xMax;
}.

The preprocessing process only needs to be performed once to generate the mesh, so that in a subsequent image processing process, there is no need to perform the preprocessing process again, but an image is directly processed based on the mesh generated in the preprocessing process. In other words, the subsequent image processing process may be implemented by through five operations: the color filtering process, the downsampling process, the Gaussian blur process, the upsampling process and the image merging process.

For the color filtering process, only one rendering process is needed. For example, when halo special effect processing is performed on an original image, a color value of high brightness in the original image may be extracted. Generally, brightness of pixels is compared with a preset brightness threshold, and a pixel of which brightness is higher than the threshold is selected as a target pixel, to determine a render target (a target image) based on the target pixel. The color filtering process can be implemented by the following code, that is,
float Threshold=0.9; //preset threshold
float3 color=SAMPLE(ColorRT,uv); //sample a color value of a current pixel
float brightness=Max3(color.r,color.g,color.b); //calculate color brightness and take a maximum value of rgb
color=color*max(0,brightness-Threshold)/brightness I/A part of which brightness higher than the threshold is normalized and multiplied by an original pixel color to obtain a filtered color

For example, as shown in FIG. 4, input color information is determined based on the original image 41 shown in FIG. 4, and then the color is filtered, in other words, a color greater than a set value (the brightness threshold) is retained, to obtain an image after color filtering, and then a target image (the target image 42) is rendered based on the filtered color.

For the downsampling process, the halo effect requires a highlight part to have different levels and ranges of diffusion effects. Therefore, downsampling and Gaussian blur are generally performed a plurality of times to achieve a final halo effect. Only one rendering process is needed. First, the pregenerated special mesh is used for rendering. The target image is drawn based on resolutions corresponding to a plurality of downsamplings and different regions (mesh cells) in the mesh as shown in FIG. 7. Because sizes of rectangles (the mesh cells) are different, downsampling is achieved. Because the special mesh is used for drawing, one Draw Call can draw to a plurality of rectangular regions. Next, as shown in FIG. 8, a color of the target image is copied to a plurality of corresponding rectangular regions in the mesh. Finally, as shown in FIG. 9, a final downsampled image is obtained after the copying is completed.

For the Gaussian blur process, after the downsampled image is determined, pixel pints in the downsampled image are blurred, which may be color diffusion. During actual application, the process of performing Gaussian blur processing on the pixel points in the downsampled image may include horizontal processing and vertical processing. As shown in FIG. 12, the horizontal Gaussian blur is performed on the pixel points in the target image to obtain the horizontal Gaussian blur processing result, and then the vertical Gaussian blur is performed on the pixel points of the horizontal Gaussian blur processing result to obtain the vertical Gaussian blur processing result. In this way a final Gaussian blur image (a blurred image) is obtained through two rendering processes.

For the upsampling process, only one rendering process is needed. First, the list of the UV ranges corresponding to the six rectangles in the mesh stored in the preprocessing process is obtained. Different rectangles are sampled from the downsampled image and the Gaussian blur image based on the list, and pixel values of corresponding regions are merged based on specific weights, to merge the downsampled image and the Gaussian blur image to obtain a floodlit effect. The upsampling process can be implemented by the following code, that is,

```
  float2 uv; //draw an input UV value full screen
  float3 color; //output a color value
  for (int n=0;n<5;++n)
  {
    float2 uvRect=i.uv*RectList[n].zw+RectList[n].xy;
    float3 color1=SAMPLE(BlurRT,uvRect) //sample a color value of a
Gaussian blur image
    float3 color2=SAMPLE(DownsampleRT,uvRect); //sample a color
value of a target image
    color+=lerp(color1,color2,lerpValue); //perform interpolating based
on a set ratio lerp Value
  }.
```

In this way, the target image shown in FIG. 15 is obtained through the upsampling process.

During actual implementation, as shown in FIG. 16, the target image (shown by number 161 in the figure) can also be superimposed on the original image (that is, shown by number 162 in the figure) to obtain a final floodlight effect (the target special effect image, that is, shown by number 173 in the figure).

In this way, in comparison with the special effect processing solution for performing special effect processing on images in related art, the special effect processing is performed on images by using the technical solution of this application to reduce a quantity of rendering processes and a quantity of textures used, thereby reducing time consumption of image processing, improving image processing efficiency, and reducing power consumption and heat generation of a device. In addition, for a problem of serious picture quality loss caused by optimizing the special effect processing process by directly reducing a quantity of downsampling rendering processes or lowering a resolution in related art, in the technical solution of this application, a special mesh is used for rendering, to replace six downsampling processes and six upsampling processes based on the mesh, so as to ensure a restoration degree of a picture.

According to embodiments of this application, first, the mesh for downsampling the target image is constructed based on the image parameter of the target image, and then the target image is downsampled through the mesh including a plurality of mesh cells to obtain the N downsampled images, and finally image fusion is performed on the plurality of downsampled images to obtain the target image corresponding to the target image. In this way, the constructed mesh including the plurality of mesh cells is used to simulate a plurality of downsampling processes, to reduce a quantity of downsamplings during image processing, thereby reducing performance consumption, improving image processing efficiency, and having wide hardware compatibility.

The following continues to describe an exemplary structure in which an image processing apparatus 455 provided in embodiments of this application is implemented as a software module. In some embodiments, as shown in FIG. 2, the software module in the image processing apparatus 455 stored in the memory 450 may include:
a construction module 4551, configured to obtain an image parameter of a target image, and construct, based on the image parameter, a mesh for downsampling the target image, the mesh including N mesh cells, the N mesh cells including at least mesh cells of different sizes, and N being a positive integer greater than 1;
a downsampling module 4552, configured to use the mesh cells in the mesh separately to downsample the target image to obtain N downsampled images; and
a fusion module 4553, configured to perform image fusion on the N downsampled images to obtain a target image.

In some embodiments, the downsampling module 4552 is further configured to: obtain sizes of the mesh cells in the mesh; and downsample the target image based on the sizes of the mesh cells to obtain the N downsampled images.

In some embodiments, the fusion module 4553 is further configured to: obtain positions of the mesh cells in the mesh; splice the N downsampled images based on the positions of the mesh cells to obtain a spliced image; and perform image fusion on the spliced image to obtain the target image.

In some embodiments, the apparatus further includes a special effect processing module. The special effect processing module is configured to: perform special effect processing corresponding to a target special effect on pixel points in the downsampled images, to obtain a special effect image including N special effect image regions, the downsampled images being in one-to-one correspondence with the special effect image regions; fuse the downsampled images with the special effect image to obtain a fused image including N fused regions, the fused region being obtained by fusing the downsampled image with a corresponding special effect image region; and upsample the fused image to obtain the target image corresponding to the target image.

In some embodiments, the special effect processing module is further configured to: perform Gaussian blur processing on the pixel points in the downsampled images when the target special effect is a halo special effect, to obtain a blurred image including N blurred image regions; fuse the downsampled image with the blurred image to obtain a fused image including N blurred special effect fused regions; and upsample the fused image to obtain a target image corresponding to the target image with the halo special effect added.

In some embodiments, the special effect processing module is further configured to: increase brightness of the pixel points in the downsampled images when the target special effect is a highlight special effect, to obtain a highlight image including N highlight image regions, fuse the downsampled images with the highlight image to obtain a fused image including N highlight special effect fused regions; and upsample the fused image to obtain a target image corresponding to the target image with the highlight special effect added.

In some embodiments, the special effect processing module is further configured to: fuse the downsampled images with corresponding special effect image regions in the special effect image to obtain the N fused regions; and determine, based on the N fused regions, the fused image including the N fused regions.

In some embodiments, the special effect processing module is further configured to: obtain first weights respectively corresponding to the downsampled images; and perform weighted fusion on the downsampled images with the corresponding special effect image regions based on the first weights, to obtain the N fused regions.

In some embodiments, the special effect processing module is further configured to: determine values of the pixel points in the fused regions based on the fused image; and upsample the fused image based on the values of the pixel points in the fused regions, to obtain the target image corresponding to the target image.

In some embodiments, the special effect processing module is further configured to: obtain second weights respectively corresponding to the fused regions; and perform weighted synthesis on the values of the pixel points in the fused regions based on the second weights, to obtain the target image corresponding to the target image.

In some embodiments, the apparatus further includes superposition module. The superposition module is configured to: obtain an original image corresponding to the target image; superimpose the original image on the target image to obtain a target special effect image; and transmit the target special effect image to a terminal, to enable the terminal to display the target special effect image.

In some embodiments, the apparatus further includes a first preprocessing module. The first preprocessing module is configured to: obtain an original image and determine a plurality of pixel points corresponding to the original image; screen the plurality of pixel points based on brightness of the pixel points, to obtain at least one target pixel point; and determine the target image based on the at least one target pixel point.

In some embodiments, the apparatus further includes a second preprocessing module. The second preprocessing module is configured to: obtain an original image and an image segmentation model; perform image segmentation on the original image based on the image segmentation model, to obtain a segmented image; and use the segmented image as the target image.

An embodiment of this application provides a computer program product or a computer program. The computer program product or the computer program includes computer instructions stored on a computer-readable storage medium. A processor of an electronic device reads the computer instructions from the computer-readable storage medium. The processor executes the computer instructions, to cause the electronic device to perform the foregoing image processing method according to embodiments of this application, such as the image processing method shown in FIG. 3.

An embodiment of this application provides a non-transitory computer-readable storage medium having executable instructions stored thereon, the executable instructions, when executed by a processor, causing the processor to perform the foregoing image processing method according to embodiments of this application, such as the image processing method shown in FIG. 3.

In some embodiments, the computer-readable storage medium may be a memory such as a read-only memory (ROM), a random access memory (RAM), an erasable programmable read-only memory (EPROM), an electrically erasable programmable read-only memory (EEPROM), a flash memory, a magnetic surface memory, an optical disk, or a CD-ROM, and may alternatively be various devices including one of the foregoing memories or any combination thereof.

In some embodiments, the executable instructions may be written in the form of program, software, software module, script, or code in any form of programming language (including compilation or interpretation language, or declarative or procedural language), and the executable instructions may be deployed in any form, including being deployed as an independent program or being deployed as a module, component, subroutine, or other units suitable for use in a computing environment.

As an example, the executable instructions may, but not necessarily, correspond to a file in a file system, and may be stored in a part of the file that stores other programs or data, for example, stored in one or more scripts in a hypertext markup language (HTML) document, stored in a single file dedicated to the program under discussion, or stored in a plurality of collaborative files (for example, a file that stores one or more modules, subroutines, or code parts).

As an example, the executable instructions may be deployed to be executed on a single electronic device, or on a plurality of electronic devices located in a single location, or on a plurality of electronic devices distributed in a plurality of locations and interconnected through a communication network.

In conclusion, embodiments of this application have the following beneficial effects:

(1) The mesh that matches the target image is used to simulate a plurality of downsampling processes, to reduce a quantity of downsamplings during image processing, thereby reducing performance consumption, improving image processing efficiency, and having wide hardware compatibility.

(2) Different target images are obtained through different image segmentation models, to carry out subsequent special effect processing processes, thereby improving applicability of an image processing process.

(3) Based on the preset cell distance, the mesh cells are arranged closely and space waste is reduced while a specific gap is left, to prevent, when special effect processing is performed on pixel points in the mesh cells, colors of edges of the mesh cells from diffusing to another adjacent mesh cell.

(4) In comparison with the special effect processing solution in related art, the special effect processing is performed on images by using the technical solution of this application to reduce a quantity of rendering processes and a quantity of textures used, thereby reducing time consumption of image processing, improving image processing efficiency, and reducing power consumption and heat generation of a device. In addition, for a problem of serious picture quality loss caused by optimizing the special effect processing process by directly reducing a quantity of downsampling rendering processes or lowering a resolution in related art, in the technical solution of this application, a special mesh is used for rendering, to replace six downsampling processes and six upsampling processes based on the mesh, so as to ensure a restoration degree of a picture.

The term “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module can be implemented using one or more processors (or processors and memory). Likewise, a processor (or processors and memory) can be used to implement one or more modules. Moreover, each module can be part of an overall module that includes the functionalities of the module. The foregoing descriptions are merely embodiments of this application and are not intended to limit the protection scope of this application. Any modification, equivalent replacement, or improvement made within the spirit and scope of this application fall within the protection scope of this application.

What is claimed is:

1. An image processing method performed by an electronic device, the method comprising:
obtaining an image parameter of a target image;
constructing, based on the image parameter, a mesh for downsampling the target image, the mesh comprising N mesh cells of different sizes, and N being a positive integer greater than 1;
using the mesh cells in the mesh separately to downsample the target image to obtain corresponding N downsampled images; and
performing image fusion on the N downsampled images to obtain a target image.

2. The method according to claim 1, wherein the using the mesh cells in the mesh separately to downsample the target image to obtain N downsampled images comprises:
obtaining sizes of the mesh cells in the mesh; and
downsampling the target image based on the sizes of the mesh cells to obtain the N downsampled images.

3. The method according to claim 1, wherein the performing image fusion on the N downsampled images to obtain a target image comprises:
obtaining positions of the mesh cells in the mesh;
performing image splicing on the N downsampled images based on the positions of the mesh cells to obtain a spliced image; and
performing image fusion on the spliced image to obtain the target image.

4. The method according to claim 1, wherein the performing image fusion on the N downsampled images to obtain a target image comprises:
performing special effect processing corresponding to a target special effect on pixel points in the downsampled images, to obtain a special effect image comprising N special effect image regions, the downsampled images being in one-to-one correspondence with the special effect image regions;
fusing the downsampled images with the special effect image to obtain a fused image comprising N fused regions, the fused region being obtained by fusing the downsampled image with a corresponding special effect image region; and
upsampling the fused image to obtain the target image corresponding to the target image.

5. The method according to claim 4, wherein the performing special effect processing corresponding to a target special effect on pixel points in the downsampled images, to obtain a special effect image comprising N special effect image regions comprises:
performing Gaussian blur on the pixel points in the downsampled images when the target special effect is a halo special effect, to obtain a blurred image comprising N blurred image regions;
the fusing the downsampled images with the special effect image to obtain a fused image comprising N fused regions comprises:
fusing the downsampled images with the blurred image to obtain a fused image comprising N blurred special effect fused regions; and
the upsampling the fused image to obtain the target image corresponding to the target image comprises:
upsampling the fused image to obtain a target image corresponding to the target image with the halo special effect added.

6. The method according to claim 4, wherein the performing special effect processing corresponding to a target special effect on pixel points in the downsampled images, to obtain a special effect image comprising N special effect image regions comprises:
increasing brightness of the pixel points in the downsampled images when the target special effect is a highlight special effect, to obtain a highlight image comprising N highlight image regions;
the fusing the downsampled images with the special effect image to obtain a fused image comprising N fused regions comprises:
fusing the downsampled images with the highlight image to obtain a fused image comprising N highlight special effect fused regions; and
the upsampling the fused image to obtain the target image corresponding to the target image comprises:
upsampling the fused image to obtain a target image corresponding to the target image with the highlight special effect added.

7. The method according to claim 4, wherein the fusing the downsampled images with the special effect image to obtain a fused image comprising N fused regions comprises:
fusing the downsampled images with corresponding special effect image regions in the special effect image to obtain the N fused regions; and
determining, based on the N fused regions, the fused image comprising the N fused regions.

8. The method according to claim 4, wherein the upsampling the fused image to obtain the target image corresponding to the target image comprises:
determining values of the pixel points in the fused regions based on the fused image; and
upsampling the fused image based on the values of the pixel points in the fused regions, to obtain the target image corresponding to the target image.

9. The method according to claim 4, wherein the method further comprises:
obtaining an original image corresponding to the target image; and
superimposing the original image on the target image to obtain a target special effect image.

10. The method according to claim 1, wherein the method further comprises:
before obtaining the image parameter of the target image:
obtaining an original image and determining a plurality of pixel points corresponding to the original image;
screening the plurality of pixel points based on brightness of the pixel points, to obtain at least one target pixel point; and
determining the target image based on the at least one target pixel point.

11. An electronic device, comprising:
a processor; a memory; and executable instructions stored in the memory; wherein:
the executable instructions, when executed by the processor, causing the electronic device to perform an image processing method including:
obtaining an image parameter of a target image;
constructing, based on the image parameter, a mesh for downsampling the target image, the mesh comprising N mesh cells of different sizes, and N being a positive integer greater than 1;
using the mesh cells in the mesh separately to downsample the target image to obtain corresponding N downsampled images; and
performing image fusion on the N downsampled images to obtain a target image.

12. The electronic device according to claim 11, wherein the using the mesh cells in the mesh separately to downsample the target image to obtain N downsampled images comprises:
obtaining sizes of the mesh cells in the mesh; and
downsampling the target image based on the sizes of the mesh cells to obtain the N downsampled images.

13. The electronic device according to claim 11, wherein the performing image fusion on the N downsampled images to obtain a target image comprises:
obtaining positions of the mesh cells in the mesh;
performing image splicing on the N downsampled images based on the positions of the mesh cells to obtain a spliced image; and
performing image fusion on the spliced image to obtain the target image.

14. The electronic device according to claim 11, wherein the performing image fusion on the N downsampled images to obtain a target image comprises:
performing special effect processing corresponding to a target special effect on pixel points in the downsampled images, to obtain a special effect image comprising N special effect image regions, the downsampled images being in one-to-one correspondence with the special effect image regions;
fusing the downsampled images with the special effect image to obtain a fused image comprising N fused regions, the fused region being obtained by fusing the downsampled image with a corresponding special effect image region; and
upsampling the fused image to obtain the target image corresponding to the target image.

15. The electronic device according to claim 11, wherein the method further comprises:
before obtaining the image parameter of the target image:
obtaining an original image and determining a plurality of pixel points corresponding to the original image;
screening the plurality of pixel points based on brightness of the pixel points, to obtain at least one target pixel point; and
determining the target image based on the at least one target pixel point.

16. A non-transitory computer-readable storage medium, having executable instructions stored thereon, the executable instructions, when executed by a processor of an electronic device, causing the electronic device to implement an image processing method including:
obtaining an image parameter of a target image;
constructing, based on the image parameter, a mesh for downsampling the target image, the mesh comprising N mesh cells of different sizes, and N being a positive integer greater than 1;
using the mesh cells in the mesh separately to downsample the target image to obtain corresponding N downsampled images; and
performing image fusion on the N downsampled images to obtain a target image.

17. The non-transitory computer-readable storage medium according to claim 16, wherein the using the mesh cells in the mesh separately to downsample the target image to obtain N downsampled images comprises:
obtaining sizes of the mesh cells in the mesh; and
downsampling the target image based on the sizes of the mesh cells to obtain the N downsampled images.

18. The non-transitory computer-readable storage medium according to claim 16, wherein the performing image fusion on the N downsampled images to obtain a target image comprises:
obtaining positions of the mesh cells in the mesh;
performing image splicing on the N downsampled images based on the positions of the mesh cells to obtain a spliced image; and
performing image fusion on the spliced image to obtain the target image.

19. The non-transitory computer-readable storage medium according to claim 16, wherein the performing image fusion on the N downsampled images to obtain a target image comprises:
performing special effect processing corresponding to a target special effect on pixel points in the downsampled images, to obtain a special effect image comprising N special effect image regions, the downsampled images being in one-to-one correspondence with the special effect image regions;
fusing the downsampled images with the special effect image to obtain a fused image comprising N fused regions, the fused region being obtained by fusing the downsampled image with a corresponding special effect image region; and
upsampling the fused image to obtain the target image corresponding to the target image.

20. The non-transitory computer-readable storage medium according to claim 16, wherein the method further comprises:
before obtaining the image parameter of the target image:
obtaining an original image and determining a plurality of pixel points corresponding to the original image;
screening the plurality of pixel points based on brightness of the pixel points, to obtain at least one target pixel point; and
determining the target image based on the at least one target pixel point.
